(19) United States
(12) Patent Application Publication
(10) Pub. No.: US 2026/0191180 A1
(43) Pub. Date: Jul. 9, 2026

(54) INSECT TRAP

(71) Applicant: Guohua CHENG, Ji 'an (CN)

(72) Inventor: Guohua CHENG, Ji 'an (CN)

(21) Appl. No.: 19/557,569

(22) Filed: Mar. 5, 2026

(30) Foreign Application Priority Data
Feb. 11, 2026 (CN) 202620207352.2
Feb. 11, 2026 (CN) 202630080157.3

(51) Int. Cl. A01M 1/14

(52) U.S. Cl. CPC A01M 1/145; A01M 2200/012

(57) ABSTRACT

This application provides an insect trap including a light processing assembly, a circuit assembly, and an installation housing; wherein, the light processing assembly includes a light processing plate and a reflective housing; the reflective housing is fixedly connected to the light processing plate; the reflective housing and the light processing plate enclose a light processing region; wherein, an insect-attracting adhesive is disposed on a surface of the light processing plate facing the reflective housing; the circuit assembly includes a battery, a light source, and a circuit board; the light source is configured to emit insect-attracting light; the insect-attracting light shines onto the light processing region to form transmitted light and reflected light.

### CROSS-REFERENCE TO RELATED APPLICATIONS

This application claims priority to Chinese Patent Application No. 202620207352.2, filed on Feb. 11, 2026, and No. 202630080157.3, filed on Feb. 11, 2026, which is hereby incorporated by reference in its entirety.

### TECHNICAL FIELD

This application relates to the technical field of insect trapping, and in particular, relates to an insect trap.

### BACKGROUND

The statements in this section merely provide background technical information related to the disclosure of the present application and do not necessarily constitute prior art.

In daily life, in order to prevent insect disturbance, people have learned to use various traps to capture insects (including: moths, mosquitoes, flies, etc.). Such traps typically use certain elements capable of attracting insects as bait to attract insects; the bait may be food, light, heat, or other odor substances attractive to insects.

In the trap, in addition to including the above-described bait, it generally also includes a fixing device; the fixing device prevents insects from leaving the trap and plays a capturing role. Common fixing devices may be a surface coated with adhesive; bait is disposed on the surface, and after insects are attracted by the bait, they will be captured on the surface coated with adhesive. A common bait may be a fluorescent tube, which emits light to attract insects, and an adhesive board having a surface coated with adhesive is disposed around the fluorescent tube, thereby efficiently trapping insects.

The inventor has learned that such insect traps need to be plugged into a power supply to keep the fluorescent tube in an on state. This in turn only allows such insect traps to be disposed near a socket having a pluggable power supply, and such insect traps are inconvenient to move, thereby affecting the usage scenarios of the insect traps. At the same time, the inventor has also learned that such insect traps generally need to be used in cooperation with a wall or other wall surface to increase the reflective effect, thereby also affecting the application scenarios and light-emitting effect of the mosquito-killing lamp.

### SUMMARY

Based on the above-described technical problems, this application provides an insect trap including a light processing assembly, a circuit assembly, and an installation housing; the light processing assembly includes a light processing plate and a reflective housing; the reflective housing and the light processing plate enclose a light processing region; wherein, the insect-attracting adhesive is disposed between the reflective housing and the light processing plate. The circuit assembly includes a battery, a light source, and a circuit board. The light source is configured to emit an insect-attracting light; the insect-attracting light shines onto the light processing region; the circuit board, the light source, and the battery are electrically connected; the light source is installed on the circuit board; the installation housing is fixedly connected to the light processing plate; the installation housing and the light processing plate enclose an accommodating region; the battery and the circuit board are installed in the accommodating region.

This application further provides an insect trap comprising a light processing assembly, a circuit assembly, and an installation housing. The light processing assembly includes a light processing plate, a reflective housing, and a lampshade. The reflective housing is fixedly connected to the light processing plate; the reflective housing and the light processing plate enclose a light processing region; wherein, an insect-attracting adhesive is disposed on a surface of the light processing plate facing the reflective housing; the insect-attracting adhesive is disposed between the reflective housing and the light processing plate; the lampshade is installed on a surface of the light processing plate close to the reflective housing; the lampshade is configured to enable the insect-attracting light to have a uniform brightness distribution; the circuit assembly includes a battery, a light source, and a circuit board. The light source is configured to emit the insect-attracting light; the insect-attracting light shines onto the light processing region to form transmitted light and reflected light; the circuit board, the light source, and the battery are electrically connected; the light source is installed on the circuit board; the installation housing is fixedly connected to the light processing plate; the installation housing and the light processing plate enclose an accommodating region; the battery and the circuit board are installed in the accommodating region.

This application provides an insect trap including a light processing assembly, a circuit assembly, and an installation housing. The light processing assembly includes a light processing plate and a reflective housing; the reflective housing is fixedly connected to the light processing plate; the reflective housing and the light processing plate enclose a light processing region; an insect-attracting adhesive is disposed on a surface of the reflective housing; the circuit assembly includes a battery, a light source, and a circuit board. The light source is configured to emit the insect-attracting light; the insect-attracting light shines onto the light processing region to form transmitted light and reflected light; the circuit board, the light source, and the battery are electrically connected; the light source is installed on the circuit board; the installation housing is fixedly connected to the light processing plate; the installation housing and the light processing plate enclose an accommodating region; the battery and the circuit board are installed in the accommodating region.

### BRIEF DESCRIPTION OF THE DRAWINGS

The accompanying drawings described herein are provided to further understand this application and constitute a part of this application; the illustrative embodiments of this application and the descriptions thereof are used to explain this application and do not constitute an improper limitation of this application. Hereinafter, some specific embodiments of this application will be described in detail with reference to the accompanying drawings in an illustrative rather than limiting manner. The same reference numerals in the accompanying drawings denote the same or similar components or parts; those of ordinary skill in the art should understand that the drawings are not necessarily drawn to scale, wherein:

FIG. 1 is a schematic diagram of the structure of a first insect trap provided by this application;

FIG. 2 is a schematic diagram of an exploded structure of the first insect trap as shown in FIG. 1;

FIG. 3 is a cross-sectional diagram taken along line A-A as shown in FIG. 1;

FIG. 4 is a schematic diagram of the structure of the first insect trap as shown in FIG. 1 in an open state.

FIG. 5 is a schematic diagram of the structure of the installation housing in FIG. 1;

FIG. 6 is a schematic diagram of a circuit of the insect trap provided by this application;

FIG. 7 is a schematic diagram of the structure of a light processing plate shown in FIG. 2 from a first perspective;

FIG. 8 is a schematic diagram of the structure of the light processing plate shown in FIG. 2 from a second perspective;

FIG. 9 is a schematic diagram of the structure of a lampshade;

FIG. 10 is a schematic diagram of the structure of an insect-attracting adhesive;

FIG. 11 is a schematic diagram of assembly of a reflective housing, the installation housing, and the light processing plate;

FIG. 12 is a schematic diagram of assembly in FIG. 11 from another perspective.

### DETAILED DESCRIPTION OF EMBODIMENTS

The technical solutions in the embodiments of this application will be clearly and completely described below in conjunction with the accompanying drawings in the embodiments of this application; of course, the described embodiments are only a part of the embodiments of this application, rather than all of the embodiments. Based on the embodiments of this application, all other embodiments obtained by a person of ordinary skill in the art without making creative efforts shall fall within the scope of protection of this application.

It should be noted that all directional indications (such as up, down, left, right, front, rear . . . ) in the embodiments of this application are only used to explain the relative positional relationships, movement conditions, etc. among the components under a certain specific posture (as shown in the drawings); if the specific posture changes, the directional indications shall change accordingly.

In addition, descriptions such as “first” and “second” in this application are only for descriptive purposes and shall not be construed as indicating or implying their relative importance or implicitly indicating the quantity of the indicated technical features. Thus, features defined as “first” and “second” may explicitly or implicitly include at least one such feature. In the description of this application, “plurality” means at least two, for example, two, three, etc., unless otherwise specifically defined.

In this application, unless otherwise expressly specified and limited, the terms “connected,” “fixed,” etc. shall be understood in a broad sense; for example, “fixed” can be a fixed connection, a detachable connection, or formed integrally; it can be a mechanical connection or an electrical connection; it can be a direct connection or an indirect connection through an intermediate medium; it can be internal communication between two elements or an interaction relationship between two elements, unless otherwise expressly limited. For a person of ordinary skill in the art, the specific meanings of the aforementioned terms in this application can be understood according to specific circumstances.

The drawings appearing in this application are only for illustrative explanation; the dimensions and shapes involved therein are only one form of embodiment and shall not be construed as limiting the scope of protection of the claims.

In addition, the technical solutions among the various embodiments of this application can be combined with each other, but such combination must be based on the ability of a person of ordinary skill in the art to implement; when the combination of technical solutions results in mutual contradiction or cannot be implemented, such combination shall be deemed not to exist and shall not fall within the scope of protection claimed in this application.

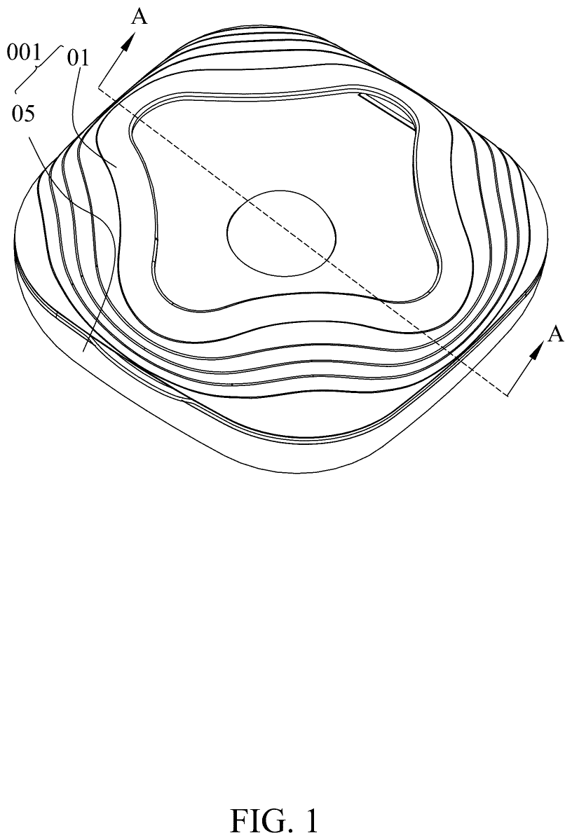

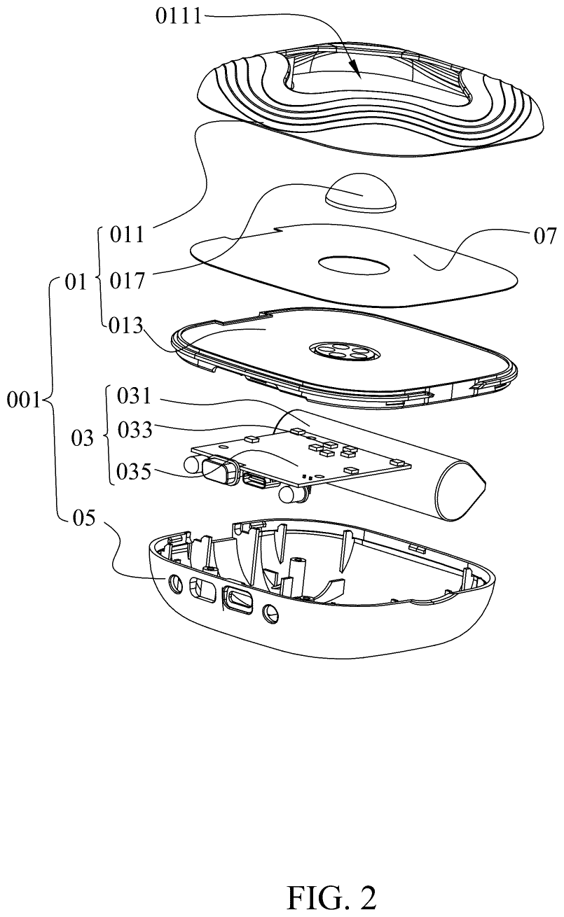

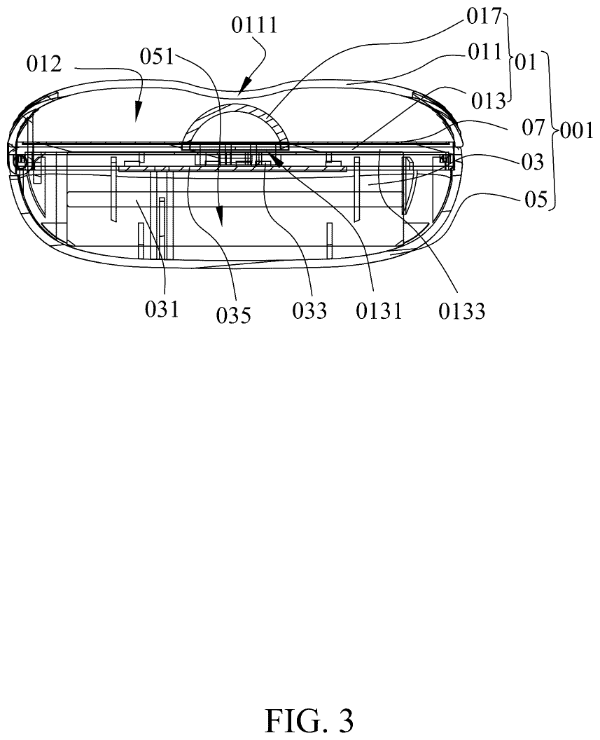

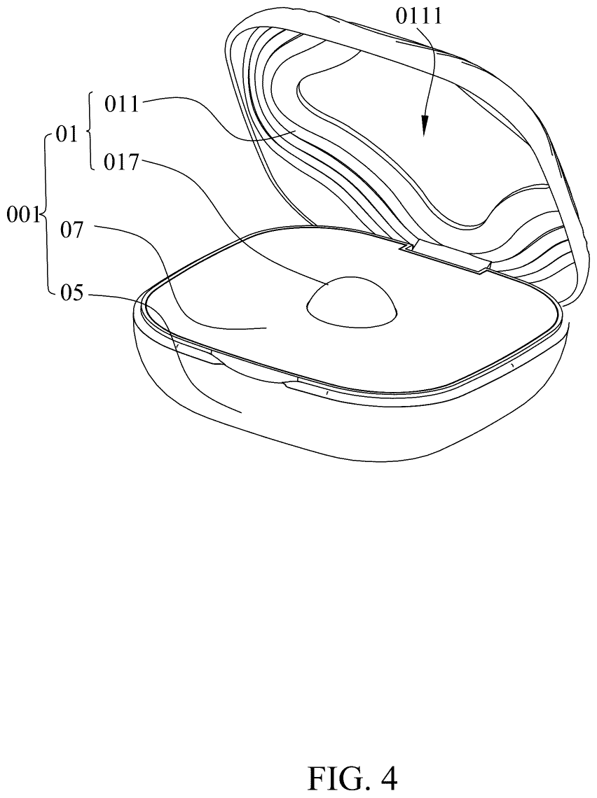

As shown in FIG. 1 and FIG. 2, FIG. 1 is a schematic diagram of the structure of a first insect trap provided by this application; FIG. 2 is a schematic diagram of an exploded structure of the first insect trap as shown in FIG. 1; FIG. 3 is a cross-sectional diagram taken along line A-A as shown in FIG. 1; FIG. 4 is a schematic diagram of the structure of the first insect trap as shown in FIG. 1 in an open state. The insect trap 001 includes a light processing assembly 01, a circuit assembly 03, and an installation housing 05; wherein, the light processing assembly 01 includes a reflective housing 011 and a light processing plate 013; wherein, the reflective housing 011 and the light processing plate 013 are fixedly connected, and the reflective housing 011 and the light processing plate 013 enclose a light processing region 012; the reflective housing 011 has a light transmission hole 0111; wherein, an insect-attracting adhesive 07 is disposed on a surface of the light processing plate 013 facing the reflective housing 011, and the insect-attracting adhesive 07 is disposed between the reflective housing 011 and the light processing plate 013; the circuit assembly 03 includes a battery 031, a light source 033, and a circuit board 035; the light source 033 is configured to emit insect-attracting light; the insect-attracting light shines onto the light processing region 012 to form transmitted light and reflected light; the circuit board 035, the light source 033 is electrically connected to the battery 031; the light source 033 is installed on the circuit board 035; the installation housing 05 and the light processing plate 013 are fixedly connected; the installation housing 05 and the light processing plate 013 enclose an accommodating region 051; the battery 031 and the circuit board 035 are installed in the accommodating region 051.

It should be noted that, in some embodiments, the reflective housing 011 may not have the light transmission hole 0111; in this case, a gap (not shown) may be provided between the reflective housing 011 and the light processing plate 013; the gap has a certain width; the insect-attracting adhesive 07 may be installed into the light processing region 012 through the gap.

In some embodiments, the insect-attracting adhesive 07 may be disposed on the surface of the light processing plate 013 facing the reflective housing 011.

It should be noted that the insect-attracting adhesive 07 is detachably connected to the reflective housing 011.

In this embodiment, the shapes of the reflective housing 011 and the light processing plate 013 are not specifically limited and may be arranged and processed into various shapes according to actual production requirements; wherein, the reflective housing 011 may be plate-shaped having a certain thickness, or may also be a housing having a certain thickness, or may also be other shape designs. When the insect-attracting adhesive 07 is disposed on the surface of the light processing plate 013 facing the reflective housing 011, at this time, the light emitted by the light source 033 first shines onto the reflective housing 011, and then the reflective housing 011 reflects the light onto the insect-attracting adhesive 07.

The fixed connection mentioned in this application may be at least one of threaded connection, buckle connection, key connection, clamping connection, insertion connection, magnetic connection, bonding, and adhesive connection. For example, the manner in which the reflective housing 011 and the light processing plate 013 are fixedly connected may be that the two can undergo relative rotation, and the rotational structure is similar to a hinge connection. The fixed connection between the installation housing 05 and the light processing plate 013 may be that the two are connected through threads.

In the first insect trap 001 of this application, the reflective housing 011 and the installation housing 05 enclose an outer contour of the insect trap 001, and it may be moved and placed anywhere. The insect-attracting adhesive 07, the light processing plate 013, and the circuit board 035 are sequentially installed from top to bottom. Wherein, the insect-attracting adhesive 07 is disposed between the reflective housing 011 and the light processing plate 013, and the circuit board 035 is disposed between the installation housing 05 and the light processing plate 013. The region between the reflective housing 011 and the light processing plate 013 is defined as the light processing region 012, and the region between the installation housing 05 and the light processing plate 013 is defined as the accommodating region 051.

During actual use, an operator may turn on the light source 033; the light source 033 emits insect-attracting light; the insect-attracting light is divided into two paths; one path is emitted through the light transmission hole 0111, and its light path shines onto the outside of the outer contour of the insect trap 001, which is referred to as “transmitted light”; after distant insects sense the “transmitted light”, they are attracted by the “transmitted light”, and eventually the insects pass through the light transmission hole 0111 and enter the light processing region 012 enclosed by the reflective housing 011 and the light processing plate 013. At the same time, another path of the insect-attracting light shines onto the reflective housing 011 and is then reflected onto the light processing plate 013, and even forms multiple reflections between the reflective housing 011 and the light processing plate 013, which is referred to as “reflected light”; this makes the insect-attracting light in this region stronger. The insect-attracting adhesive 07 is disposed on the surface of the light processing plate 013 facing the reflective housing 011; at this time, insects attracted here are easily adhered to the insect-attracting adhesive 07 during crawling or flying.

Furthermore, during actual use, after the operator has used the insect trap 001 for a period of time and the insect-attracting adhesive 07 therein is already covered with insects, at this time, since the reflective housing 011 is fixedly connected to the light processing plate 013, the reflective housing 011 and the light processing plate 013 may be easily separated, and then the insect-attracting adhesive 07 may be taken out from the surface of the light processing plate 013 facing the reflective housing 011 and replaced with a new insect-attracting adhesive 07.

It should be noted that, in this application, the materials of the light processing plate 013, the reflective housing 011, and the installation housing 05 may be at least one of plastic, silicone, or metal materials. In this application, the materials of the light processing plate 013, the reflective housing 011, and the installation housing 05 are preferably plastic materials.

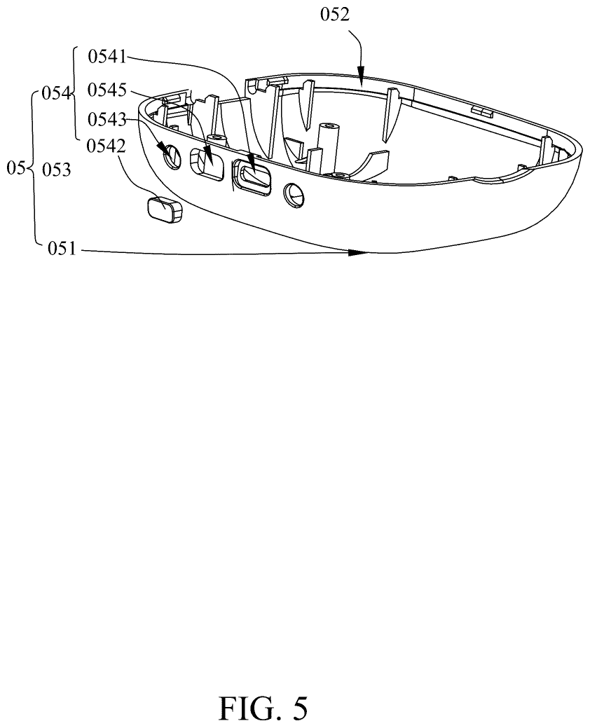

Please refer to FIG. 2, FIG. 4, and FIG. 5; FIG. 5 is a schematic diagram of the structure of the installation housing in FIG. 1; the installation housing 05 includes a bottom wall 051 and a side wall 053; the bottom wall 051 is configured to support the insect trap 001. The bottom wall 051 and the side wall 053 are fixedly connected; the bottom wall 051 and the side wall 053 enclose the installation housing 05; the installation housing 05 has an opening 052; the light processing plate 013 is disposed at the position of the opening.

The meaning of the bottom wall 051 being configured to support the insect trap 001 is that the bottom wall 051 serves as a portion where the insect trap 001 contacts an external supporting object; for example, when the insect trap 001 is placed on the ground, the bottom wall 051 contacts the ground; when the insect trap 001 is placed on a tabletop, the bottom wall 051 contacts the tabletop. The bottom wall 051 may be a planar surface, or may also be a curved surface, or of course may also be other irregular surfaces; in the selection of some embodiments of this application, the bottom wall 051 is a planar surface.

Furthermore, the bottom wall 051 may also be disposed with at least three protruding posts (not shown), which extend from the bottom wall 051 in a direction away from the light processing plate 013 to form a supporting region where the bottom wall 051 contacts the ground or where the bottom wall 051 contacts the tabletop. The shape and material of the protruding posts are not specifically limited.

The meaning of the fixed connection between the bottom wall 051 and the side wall 053 may be fixed connection, non-fixed connection, or integrally formed. Wherein, the manner of fixed connection is as described above, and the manner of non-fixed connection may be welding, interference fit, riveting, or other manners. In this application, the bottom wall 051 and the side wall 053 are connected in an integrally formed manner, and a rounded corner is designed between the bottom wall 051 and the side wall 053.

The side wall 053 is disposed with an operation indication region 054; the operation indication region 054 includes one or more of a charging port 0541, a display assembly 0543, and a switch button 0545. The charging port 0541 is electrically connected to the battery 031; the charging port 0541 is configured to externally connect with a power supply to charge the battery 031. The specification of the charging port 0541 may be selected according to industry standards and is not specifically limited herein. Wherein, in this application, a waterproof plug 0542 is further involved, and its shape matches that of the charging port 0541; the two are fixedly connected and configured to prevent dust or dirty water in the surrounding environment from entering the charging port 0541 and affecting the normal use of the insect trap 001.

The operation indication region 054 further includes the display assembly 0543; the display assembly 0543 is at least one of a display screen, an indicator light, or a speaker; the display assembly 0543 is electrically connected to the circuit board 035. Wherein, the display screen may be a touch display screen, or may be a conventional display screen; the touch display screen may realize at least one of the functions of “on/off”, “brightness”, “time setting”, “sleep”, or “level selection”. At this time, the touch display screen already includes the switch button 0545, which is equivalent to integrating the display assembly 0543 and the switch button 0545 together. The indicator light may serve as a prompt function through one of color, brightness, or flashing changes of a light bead. The speaker serves as a prompt function by emitting sound.

The operation indication region 054 further includes the switch button 0545; the switch button 0545 is electrically connected to the circuit board 035 and configured to control the light source 033 to turn on or turn off, or configured to control the brightness of the light source 033. The switch button 0545 may implement at least one of the functions of “on/off”, “brightness”, “time setting”, “sleep”, or “level selection”.

In a first embodiment of this application, the operation indication region 054 of the insect trap 001 includes the charging port 0541, the switch button 0545, and the indicator light 0543. The charging port 0541, the switch button 0545, and the indicator light 0543 are electrically connected, and the manner of electrical connection may be direct wire connection, or may also be indirect wire connection; for example, the three are all mounted on the circuit board 035 and are electrically connected through the circuit board 035.

In this application, the light source 033 is a light emitting diode 033, which is electrically connected to the circuit board 035.

In this application, the operation indication region 054 is a region divided according to function, and its specific position and shape are not specifically limited.

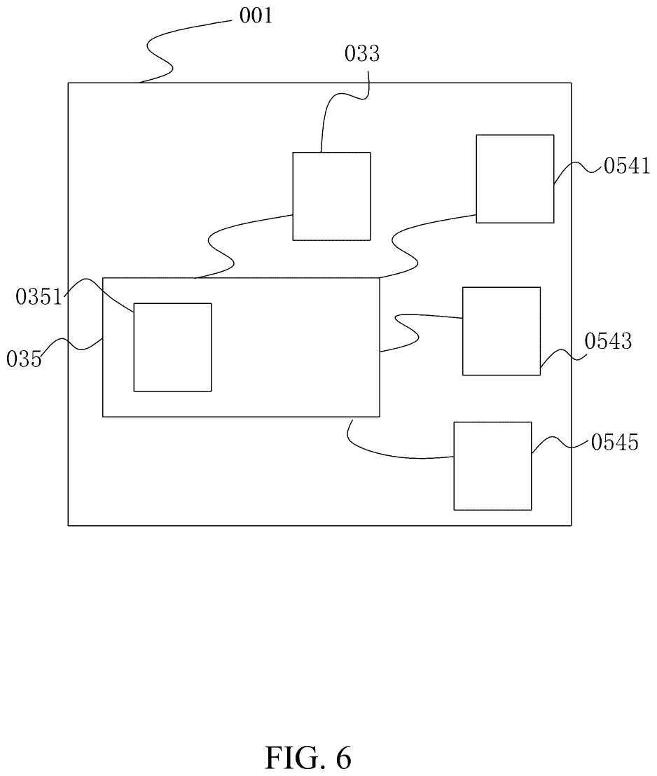

Simultaneously refer to FIG. 5 and FIG. 6, which are a schematic diagram of a circuit of the insect trap 001 provided by this application. The charging port 0541, the switch button 0545, and the indicator light 0543 constitute one operation indication region 054. Wherein, the charge port 0541 is configured to externally connect to mains power; the charge port 0541, the switch button 0545, and the indicator light 0543 are all installed on the circuit board 035; a processing unit 0351 is disposed on the circuit board 035; the processing unit 0351 may be at least one of a processor, a chip, a single-chip microcomputer, or a central processing unit (CPU). The processing unit 0351 adjusts the on/off state or brightness level of the indicator light 0543 and the light emitting diode 033 according to an instruction issued by the switch button 0545.

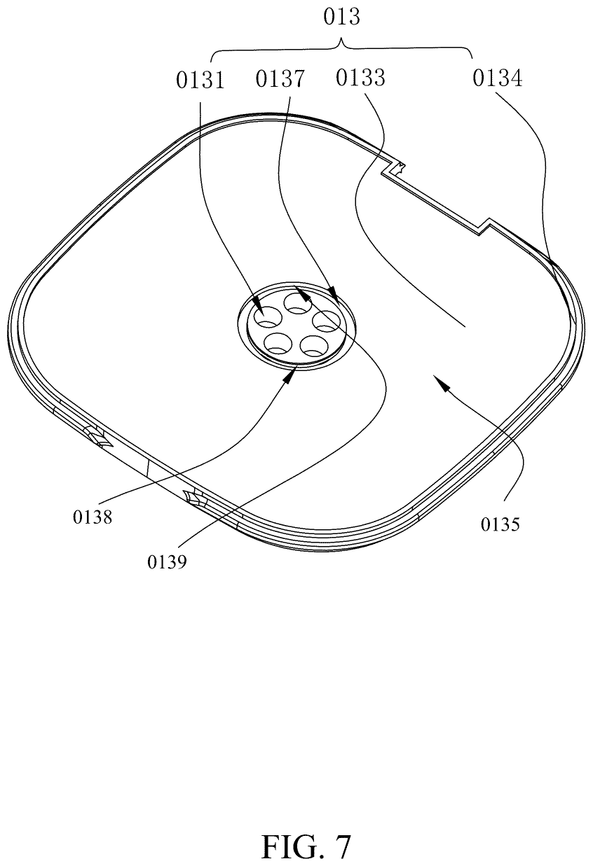

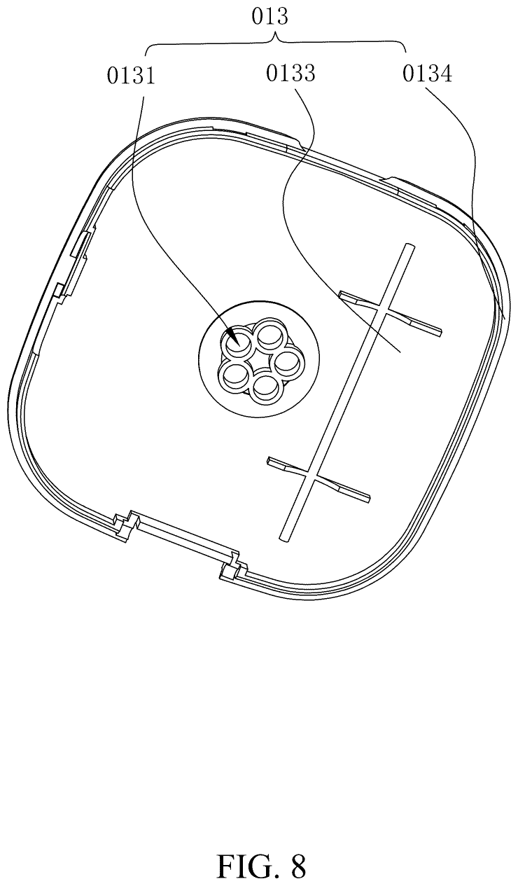

Please simultaneously refer to FIG. 2, FIG. 3, FIG. 4, FIG. 7, and FIG. 8; FIG. 7 is a schematic diagram of the structure of the light processing plate shown in FIG. 2 from a first perspective; FIG. 8 is a schematic diagram of the structure of the light processing plate shown in FIG. 2 from a second perspective. The light processing plate 013 is configured to process the insect-attracting light emitted by the light source 033; the light processing plate 013 includes a light transmission portion 0131 and a supporting portion 0133; the supporting portion 0133 and the light transmission portion 0131 are fixedly connected; the meaning of the fixed connection here is the same as described above and will not be repeated. The supporting portion 0133 may be made of a non-light-transmitting material; at this time, the insect-attracting light emitted by the light source 033 can only be emitted from the light transmission portion 0131; of course, the supporting portion 0131 may also be made of a light-transmitting material; at this time, the insect-attracting light emitted by the light source 033 may be emitted from the entire light processing plate. The light transmission portion 0131 is disposed in alignment with the light source 033; the insect-attracting light shines onto the light processing region 012 through the light transmission portion 0131, and then shines onto the light transmission hole 0111 to form the transmitted light; the insect-attracting light shines onto the reflective housing 011 to form the reflected light. The insect-attracting adhesive 07 is disposed on the surface of the supporting portion 0133 facing the reflective housing 011; the light reflected back by the reflective housing 011 shines onto the surface of the supporting portion 0133 facing the reflective housing 011, and the insect-attracting adhesive 07 is placed on this surface; under multiple reflections between the reflective housing 011 and the surface of the supporting portion 0133 facing the reflective housing 011, the brightness of the light in this region becomes stronger, thereby better attracting insects. After insects arrive at this region, they are adhered by the insect-attracting adhesive 07, thereby completing insect capture.

In other embodiments of this application, the light transmission portion 0131 is disposed in alignment with the light source 033; the insect-attracting light shines onto the light processing region 012 through the light transmission portion 0131, and then shines onto the gap (not shown) to form the transmitted light; the insect-attracting light shines onto the reflective housing 011 to form the reflected light. The insect-attracting adhesive 07 is disposed on the surface of the supporting portion 0133 facing the reflective housing 011; the light reflected back by the reflective housing 011 shines onto the surface of the supporting portion 0133 facing the reflective housing 011, and the insect-attracting adhesive 07 is placed on this surface; under multiple reflections between the reflective housing 011 and the surface of the supporting portion 0133 facing the reflective housing 011, the brightness of the light in this region becomes stronger, thereby better attracting insects. After insects arrive at this region, they are adhered by the insect-attracting adhesive 07, thereby completing insect capture. In some embodiments of this application, the light processing plate 013 is configured to process the insect-attracting light emitted by the light source 033; the light processing plate 013 includes the light transmission portion 0131 and the supporting portion 0133; the light transmission portion 0131 and the supporting portion 0133 are fixedly connected; the light transmission portion 0131 is disposed in alignment with the light source 033; the insect-attracting light shines onto the light processing region 012 through the light transmission portion 0131; wherein, the insect-attracting adhesive 07 is installed on a surface of the reflective housing 011 close to the light source 033, and is configured such that the insect-attracting light shines onto the insect-attracting adhesive 07; the insect-attracting adhesive 07 is detachably connected to the reflective housing 011. In this embodiment, the insect-attracting light shines directly onto the insect-attracting adhesive 07.

Furthermore, in some embodiments, as shown in FIG. 1, FIG. 2, and FIG. 4, the insect trap 001 includes a working state and a non-working state; when in the working state, the reflective housing 011 and the installation housing 05 are close to each other, and are configured such that the reflective housing 011 and the installation housing 05 are in a closed state; when in the non-working state, the reflective housing 011 and the installation housing 05 are separated from each other, and are configured such that the reflective housing 011 and the installation housing 05 are in an open state.

The light transmission portion 0131 is arranged to have an overall circular shape; at this time, the light transmission portion 0131 is a light-emitting hole structure; the light emitted by the light emitting diode 033 passes through the light-emitting hole and then penetrates into the light processing region 012. During the process of passing through the light-emitting hole, the light transmission portion 0131, as a light-emitting hole structure, limits the light path of the light emitted by the light source 033, thereby preventing scattering of the insect-attracting light during this process and making the insect-attracting light more focused. After the insect-attracting light penetrates into the light processing region 012, it is divided into the above-described “reflected light” and “transmitted light”.

In addition, the supporting portion 0133 further includes an outer edge region; a protruding platform 0134 is designed along the outer edge region; the protruding platform 0134 encloses an installation region 0135; the insect-attracting adhesive 07 is installed in the installation region 0135. It is clear that the protruding platform 0134 is configured to limit the insect-attracting adhesive 07. A projection area of the light transmission portion 0131 is smaller than a projection area of the light transmission hole 0111. The meaning of projection area is that, taking a plane where the light processing plate 013 is located as a horizontal plane, the projection of the light transmission portion 0131 thereon is the projection area of the light transmission portion 0131, and the projection of the light transmission hole 0111 thereon is the projection area of the light transmission hole 0111. Designing the light transmission hole 0111 here to be a little larger than the light transmission portion 0131 enables insects to more easily fly or crawl in along the light transmission hole 0111, fully utilizing the insect-attracting light emitted by the light source 033. It should be noted that the shape of the light transmission hole 0111 is not specifically limited and may be square, rectangular, diamond-shaped, circular, elliptical, or other shapes. The quantity of the light transmission hole 0111 is also not specifically limited and may be a single hole or may be multiple holes forming a hole module.

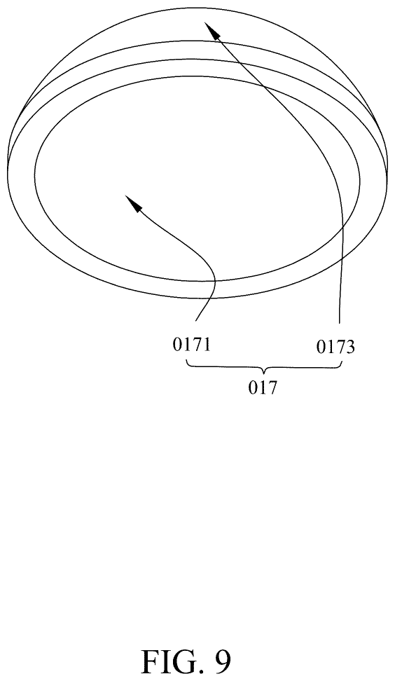

Please simultaneously refer to FIG. 7, FIG. 8, and FIG. 9; wherein, FIG. 9 is a schematic diagram of the structure of a lampshade. The light processing assembly 01 further includes a lampshade 017, at least a portion of which is located on a surface of the light transmission portion 0131 close to the reflective housing 011; the lampshade 017 is configured to enable the insect-attracting light to have a uniform brightness distribution. The lampshade 017 includes an inner surface 0171 and an outer surface 0173; wherein, the inner surface 0171 and the outer surface 0173 are oppositely arranged; the inner surface 0171 is a side close to the light source 033; the outer surface 0173 is a side close to the reflective housing 011. Extending from the inner surface 0171 toward the outer surface 0173, at least a portion of the lampshade 017 is designed as an arc surface. A side of the light processing plate 013 close to the reflective housing 011 is provided with an annular protrusion (not shown); the annular protrusion is disposed surrounding the light transmission portion 0131; the lampshade 017 is disposed in the annular protrusion.

It should be noted that, as shown in the above drawings, in some embodiments, the annular protrusion may be replaced with a retaining groove 0137; the retaining groove 0137 is disposed surrounding the light transmission portion 0131; the lampshade 017 is disposed in the retaining groove 0137. It should be noted that the shape of the lampshade 017 may be a hemispherical surface, an ellipsoidal surface, multiple curved surfaces, or an arc surface. In this application, on the premise that at least a portion of the lampshade 017 is designed as an arc surface, the shape of the lampshade 017 may be considered as a hemispherical surface. Of course, designing the shape of the lampshade 017 as other above-listed shapes also falls within the protection scope of this application.

The function of the lampshade 017 is to protect the light source 033 while adjusting the light path of the insect-attracting light emitted by the light source 033; in some embodiments, the lampshade 017 may be arranged as a convex lens to perform light focusing treatment on the insect-attracting light emitted by the light source 033. Furthermore, in a first scenario, the retaining groove 0137 includes an inner peripheral wall 0138; the lampshade 017 matches the inner peripheral wall 0138; at this time, the inner peripheral wall 0138 matches the inner surface 0171 of the lampshade 017; in a second scenario, the retaining groove 0137 includes an outer peripheral wall 0139; the lampshade 017 matches the outer peripheral wall 0139; at this time, the outer peripheral wall 0139 matches the outer surface 0173 of the lampshade 017; in a third scenario, the retaining groove 0137 includes the inner peripheral wall 0138 and the outer peripheral wall 0139. The inner peripheral wall 0138 and the outer peripheral wall 0139 respectively match the inner surface 0171 and the outer surface 0173 of the lampshade 017. Wherein, the thickness between the inner surface 0171 and the outer surface 0173 of the lampshade 017 is slightly smaller than the distance between the inner peripheral wall 0138 and the outer peripheral wall 0139 of the retaining groove 0137. Similarly, when the shape of the lampshade 017 changes, in order to maintain matching with the lampshade 017, the shape of the retaining groove 0137 also changes accordingly; likewise, the shapes of the inner peripheral wall 0138 and the outer peripheral wall 0139 also change accordingly. Specific changes of the retaining groove 0137 will not be listed one by one.

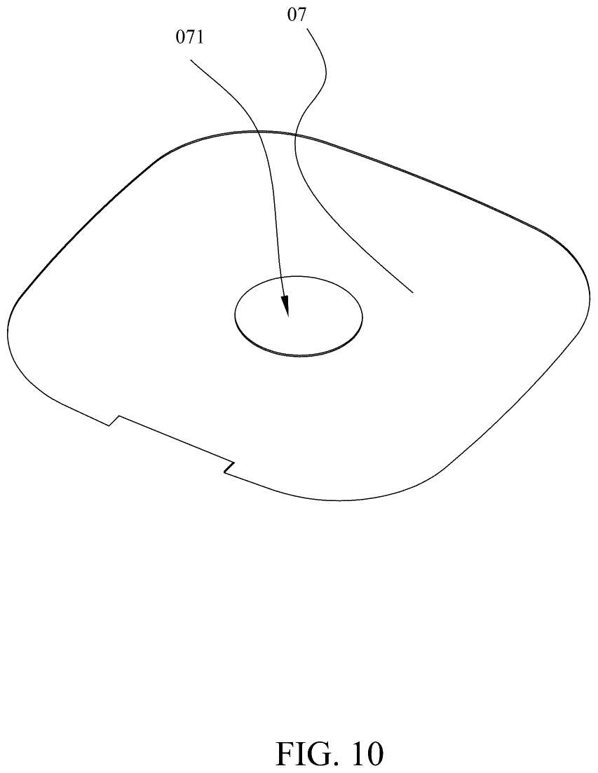

Please refer to FIG. 2 and FIG. 10; FIG. 10 is a schematic diagram of the structure of the insect-attracting adhesive. A middle portion of the insect-attracting adhesive 07 has a notch 071; the shape of the notch 071 is substantially the same as the shape of the retaining groove 0137 (or the annular protrusion); for example, the shape of the notch 071 and the shape of the retaining groove 0137 (or the annular protrusion) are both circular, or both quadrilateral, or both elliptical. It is configured such that the retaining groove 0137 (or the annular protrusion) limits the insect-attracting adhesive 07 through the notch 071; the position of the lampshade 017 is disposed corresponding to the position of the notch 071. After disposing the lampshade 017, the insect-attracting light emitted by the light source 033 and passing through the light transmission portion 0131 first shines onto the lampshade 017 for light homogenization treatment, and then is emitted from the lampshade 017 and divided into the above-described “reflected light” and “transmitted light”. As the “transmitted light” extends with distance and gradually moves away from the insect trap 001, its light gradually weakens; whereas the “reflected light” is confined within the light processing region 012, and its light intensity does not dissipate much, thereby ensuring effective attraction of insects and preparing for further capture through the insect-attracting adhesive 07.

In this application, the insect-attracting adhesive 07 may be a mosquito-attracting adhesive board; the material of the mosquito-attracting adhesive board may be hard cardboard, or may also be a plastic film, or may also be a composite material in which a plastic film wraps hard cardboard, or may also be a plastic board; the mosquito-attracting adhesive board has an overall plate-shaped structure with a certain thickness, and the thickness range may be 0.1 millimeters to 5 millimeters.

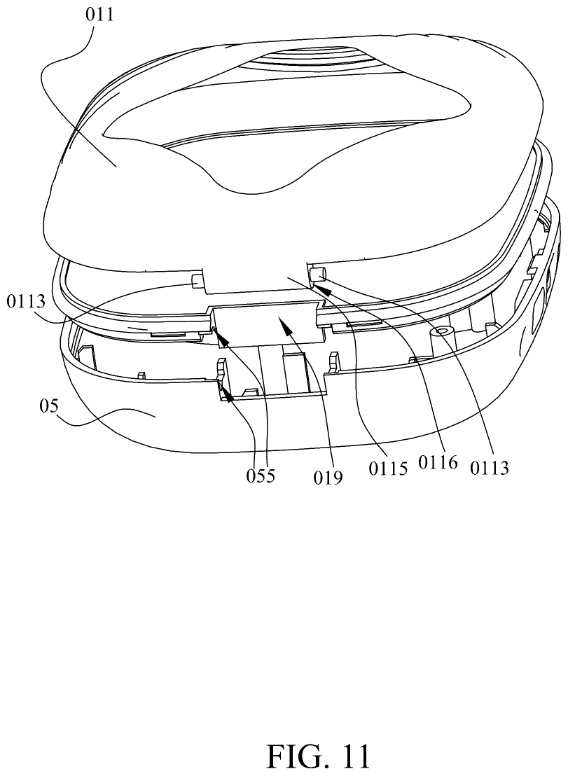

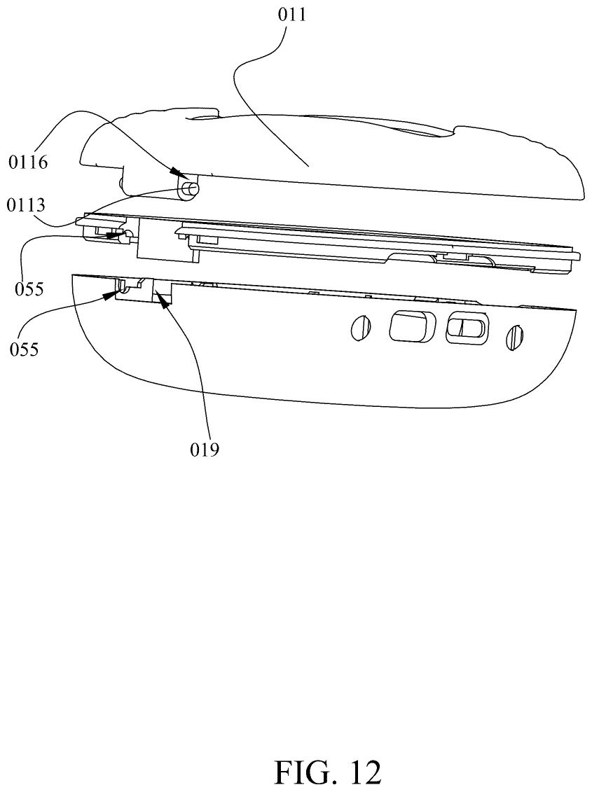

Please refer to FIG. 1, FIG. 2, FIG. 4, FIG. 11, and FIG. 12. FIG. 11 is a schematic diagram of assembly of the reflective housing, the installation housing, and the light processing plate; FIG. 12 is an enlarged view of region B in FIG. 1. The insect trap 001 provided by this application includes the working state and the non-working state. When in the working state, the reflective housing 011 and the installation housing 05 are close to each other and are configured such that the reflective housing 011 and the installation housing 05 are in the closed state; when in the non-working state, the reflective housing 011 and the installation housing 05 are separated from each other and are configured such that the reflective housing 011 and the installation housing 05 are in the open state.

The manner in which the reflective housing 011 and the installation housing 05 switch between the open state and the closed state (wherein the closed state is a normal use state) will be described in detail below; the manner may be one or more of the above-described fixed connection manners and will not be repeated. The following examples are described in detail; however, the examples of the manners are not regarded as limiting the protection scope of this application.

A first manner: the reflective housing 011 includes an installation rotating shaft 0113; the installation housing 05 includes an installation groove 055; positions of the installation rotating shaft 0113 and the installation groove 055 correspond to each other; the installation rotating shaft 0113 is installed in the installation groove 055, and the installation rotating shaft 0113 may rotate about the installation groove 055, which is configured such that the reflective housing 011 and the installation housing 05 rotate.

A second manner: the reflective housing 011 includes the installation groove 055; the installation housing 05 includes the installation rotating shaft 0113; positions of the installation rotating shaft 0113 and the installation groove 055 correspond to each other; the installation rotating shaft 0113 is installed in the installation groove 055, and the installation rotating shaft 0113 may rotate about the installation groove 055, which is configured such that the reflective housing 011 and the installation housing 05 rotate.

A third manner: the reflective housing 011 includes the installation rotating shaft 0113; after the installation housing 05 and the light processing plate 013 are matched and installed, the installation housing 05 and the light processing plate 013 enclose one installation groove 055 at a position corresponding to the installation rotating shaft 0113; the installation rotating shaft 0113 is installed in the installation groove 055, and the installation rotating shaft 0113 may rotate about the installation groove 055, which is configured such that the reflective housing 011 and the installation housing 05 rotate. It should be noted that, in order to cooperate with rotation, the installation rotating shaft 0113 is preferably cylindrical, and the installation groove is preferably a circular hole. In the embodiments of this application, the third manner is selected as an exemplary description.

Furthermore, the reflective housing 011 is disposed with a connecting wall 0115; the connecting wall 0115 is a wall having a certain thickness and has end surfaces 0116; installation rotating shafts 0113 having substantially the same shape are respectively disposed on the end surfaces 0116. At the same time, the insect-attracting adhesive 07, the light processing plate 013, and the side wall 053 have an installation notch 019. The installation groove 055 may be located at two ends of the installation notch 019 of the side wall 053, or may also be located at two ends of the installation notch 019 of the light processing plate 013, or may also be located at two ends of the installation notch 019 of the light processing plate 013 and the side wall 053. In this application, it is selected to have the installation groove 055 located at two ends of the installation notch 019 of the light processing plate 013 and the side wall 053.

Furthermore, in some embodiments of this application, the quantity of the light emitting diode 033 is at least two. For example, the quantity of the light emitting diode 033 is set as five, and the quantity of the light transmission portion 0131 is also five; one light emitting diode 033 corresponds to one light transmission portion 0131, and light emitted by each light emitting diode 033 is transmitted along the corresponding light transmission portion 0131.

The electrical connection mentioned in this application can be a physical connection by means of wires, or can be a wireless electrical signal connection; the electrical signal herein can be at least one of a current signal, a voltage signal, a resistance signal, a Bluetooth signal, or a Wi-Fi signal.

The descriptive terms “substantially,” “approximately,” and “close to” mentioned in this application mean that, relative to a standard value, the fluctuation range can vary within ±20%.

The term “at least one” mentioned in this application means that it can be one situation among them, or can be a coexistence of multiple situations. For example, “at least one of A, B, and C” includes all combinations such as A alone, B alone, C alone, A and B coexisting, A and C coexisting, and other arrangement combinations. Details are not explained one by one.

The meaning of “A and/or B” mentioned in this application is that it may be one of the situations or may be coexistence in multiple situations. For example, it includes the situation in which A appears alone, B appears alone, or A and B coexist. Details are not explained one by one.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A or B”, unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

The foregoing describes only embodiments of this application; it should be noted here that those of ordinary skill in the art can make improvements without departing from the inventive concept of this application, and such improvements shall fall within the protection scope of this application.

What is claimed is:

1. An insect trap, characterized by comprising:
a light processing assembly comprising:
a light processing plate;
a reflective housing; the reflective housing and the light processing plate enclose a light processing region;
wherein, the insect-attracting adhesive is disposed between the reflective housing and the light processing plate;
a circuit assembly comprising:
a battery;
a light source; the light source is configured to emit an insect-attracting light; the insect-attracting light shines onto the light processing region;
a circuit board; the circuit board, the light source, and the battery are electrically connected; the light source is installed on the circuit board;
an installation housing; the installation housing is fixedly connected to the light processing plate; the installation housing and the light processing plate enclose an accommodating region; the battery and the circuit board are installed in the accommodating region.

2. The insect trap according to claim 1, characterized in that, the reflective housing has a light transmission hole.

3. The insect trap according to claim 1, characterized in that, the installation housing comprises:
a bottom wall;
a side wall; the bottom wall is fixedly connected to the side wall; the side wall and the bottom wall enclose the installation housing; the installation housing has an opening; the light processing plate is disposed at the position of the opening.

4. The insect trap according to claim 3, characterized in that, the side wall or the bottom wall is disposed with an operation indication region; the operation indication region comprises a charging port; the charging port is electrically connected to the battery; the charging port is configured to externally connect with a power supply to charge the battery.

5. The insect trap according to claim 4, characterized in that, the operation indication region further comprises a display assembly; the display assembly is at least one of a display screen, an indicator light, or a speaker; the display assembly is electrically connected to the circuit board.

6. The insect trap according to claim 4, characterized in that, the operation indication region comprises a switch button; the switch button is electrically connected to the circuit board and configured to control the light source to turn on or turn off, or configured to control the brightness of the light source.

7. The insect trap according to claim 1, characterized in that, the light processing plate is disposed between the insect-attracting adhesive and the circuit board.

8. The insect trap according to claim 1, characterized in that, the light processing plate is configured to process the insect-attracting light emitted by the light source; the light processing plate comprises a light transmission portion and a supporting portion; the supporting portion is fixedly connected to the light transmission portion;
the light transmission portion is disposed in alignment with the light source; the insect-attracting light shines onto the light processing region through the light transmission portion.

9. The insect trap according to claim 8, characterized in that, the supporting portion comprises an outer edge region; a protruding platform is designed along the outer edge region and configured to limit the insect-attracting adhesive.

10. The insect trap according to claim 8, characterized in that, the light processing assembly further comprises:
a lampshade, at least a portion of which is located on a surface of the light transmission portion close to the reflective housing; the lampshade is configured to enable the insect-attracting light to have a uniform brightness distribution.

11. The insect trap according to claim 10, characterized in that, the lampshade comprises an inner surface and an outer surface; wherein, the inner surface and the outer surface are oppositely arranged;
the inner surface is a side close to the light source; the outer surface is a side close to the reflective housing;
extending from the inner surface toward the outer surface, at least a portion of the lampshade is designed as an arc surface.

12. The insect trap according to claim 11, characterized in that, a side of the light processing plate close to the reflective housing is provided with an annular protrusion; the annular protrusion is disposed surrounding the light transmission portion; the lampshade is disposed in the annular protrusion.

13. The insect trap according to claim 12, characterized in that, a middle portion of the insect-attracting adhesive has a notch; the shape of the notch is substantially the same as the shape of the annular protrusion and is configured such that the annular protrusion limits the insect-attracting adhesive through the notch; the position of the lampshade corresponds to the position of the notch.

14. An insect trap, characterized by comprising:
a light processing assembly comprising:
a light processing plate;
a reflective housing; the reflective housing is fixedly connected to the light processing plate; the reflective housing and the light processing plate enclose a light processing region; wherein, an insect-attracting adhesive is disposed on a surface of the light processing plate facing the reflective housing; the insect-attracting adhesive is disposed between the reflective housing and the light processing plate;
a lampshade installed on a surface of the light processing plate close to the reflective housing; the lampshade is configured to enable the insect-attracting light to have a uniform brightness distribution;
a circuit assembly comprising:
a battery;
a light source; the light source is configured to emit the insect-attracting light; the insect-attracting light shines onto the light processing region to form transmitted light and reflected light;
a circuit board; the circuit board, the light source, and the battery are electrically connected; the light source is installed on the circuit board;
an installation housing; the installation housing is fixedly connected to the light processing plate; the installation housing and the light processing plate enclose an accommodating region; the battery and the circuit board are installed in the accommodating region.

15. The insect trap according to claim 14, characterized in that, the reflective housing has a light transmission hole;
the light processing plate is configured to process the insect-attracting light emitted by the light source; the light processing plate comprises a light transmission portion and a supporting portion; the supporting portion is fixedly connected to the light transmission portion;
the light transmission portion is disposed in alignment with the light source; the insect-attracting light shines onto the light processing region through the light transmission portion;
the insect-attracting light shines onto the light transmission hole to form the transmitted light; the insect-attracting light shines onto the reflective housing to form the reflected light;
the insect-attracting adhesive is disposed on a surface of the supporting portion facing the reflective housing.

16. The insect trap according to claim 14, characterized in that, the reflective housing comprises an installation rotating shaft; the installation housing comprises an installation groove;
positions of the installation rotating shaft and the installation groove correspond to each other; the installation rotating shaft is installed in the installation groove, and the installation rotating shaft may rotate about the installation groove, which is configured such that the reflective housing rotates relative to the installation housing; or
the reflective housing comprises the installation groove; the installation housing comprises the installation rotating shaft;
positions of the installation rotating shaft and the installation groove correspond to each other; the installation rotating shaft is installed in the installation groove, and the installation rotating shaft may rotate about the installation groove, which is configured such that the reflective housing rotates relative to the installation housing.

17. An insect trap, characterized by comprising:
a light processing assembly comprising:
a light processing plate;
a reflective housing; the reflective housing is fixedly connected to the light processing plate; the reflective housing and the light processing plate enclose a light processing region;
wherein, an insect-attracting adhesive is disposed on a surface of the reflective housing;
a circuit assembly comprising:
a battery;
a light source; the light source is configured to emit the insect-attracting light; the insect-attracting light shines onto the light processing region to form transmitted light and reflected light;
a circuit board; the circuit board, the light source, and the battery are electrically connected; the light source is installed on the circuit board;
an installation housing; the installation housing is fixedly connected to the light processing plate; the installation housing and the light processing plate enclose an accommodating region; the battery and the circuit board are installed in the accommodating region.

18. The insect trap according to claim 17, characterized in that, the light processing plate is configured to process the insect-attracting light emitted by the light source; the light processing plate comprises a light transmission portion and a supporting portion; the supporting portion is fixedly connected to the light transmission portion;
the light transmission portion is disposed in alignment with the light source; the insect-attracting light shines onto the light processing region through the light transmission portion;
wherein, the insect-attracting adhesive is installed on a surface of the reflective housing close to the light source, and is configured such that the insect-attracting light shines onto the insect-attracting adhesive;
the insect-attracting adhesive is detachably connected to the reflective housing.

19. The insect trap according to claim 17, characterized by further comprising a lampshade; the lampshade is installed on the light transmission portion and configured to make the insect-attracting light emitted by the light source more uniform.
